(19) United States
(12) Patent Application Publication
(10) Pub. No.: US 2006/0111938 A1
(43) Pub. Date: May 25, 2006

(54) Method of delivering diagnostic services

(75) Inventor: Marco N. Vitiello, Miami, FL (US)

Correspondence Address: ROBERT S. LIPTON, ESQUIRE, 201 NORTH JACKSON STREET, P. O. BOX 934, MEDIA, PA, 19063-0934, US

(73) Assignee: Medical Technologies Unlimited, Inc., Miami, FL (US)

(21) Appl. No.: 10/997,786

(22) Filed: Nov. 24, 2004

(51) Int. Cl. G06Q 10/00

(52) U.S. Cl. 705/2

(57) ABSTRACT

The Invention is a method of providing medical diagnostic services. An examination provider subscribes to a subscriber network and receives examination equipment, protocols and training during the term of the examination provider's subscription as a benefit of that subscription. The examination provider conducts physical examinations of patients utilizing the examination equipment and provides examination data to an evaluating entity. The evaluating entity evaluates the data using an automated expert system. A network administrator submits claims for payment to payors and pays a testing fee to the examination provider and a reading fee to the evaluating entity.

### BACKGROUND OF THE INVENTION

1. Field of the Invention

The Invention is a method of providing medical diagnostic services. The method of the Invention is useful where access to a diagnostic technology may be limited by patent protection, by high equipment cost or by a requirement for special expertise in interpreting results. The method of the Invention is particularly useful for implementing dynamic neuromyography technology such as the Comprehensive Neuromuscular Profiler (CNMP™) technology of Medical Technologies Unlimited and as described in pending PCT Patent Application number PCT/US 04/22210 filed Jul. 9, 2004, which is hereby incorporated by reference as if set forth in full herein; the National Stage of which was entered into in the USPTO on Aug. 9, 2004 and was assigned U.S. application Ser. No. 10/504,031. The technology described in U.S. patent application Ser. No. 10/504,031 is hereinafter described as “dynamic neuromyography.” Dynamic neuromyography technology allows evaluation of muscular and soft tissue injuries.

2. Description of the Prior Art

The use of independent providers of diagnostic services is familiar in the medical field. Examples include providers of laboratory services, such as providers of blood analysis services, and providers of imaging services, such as providers of X-ray imaging, magnetic resonance imaging (“MRI”) or computed axial tomography (“CAT”) imaging services.

In each of these existing services, a physician prescribes the service for a patient. The patient then schedules the prescribed service with the service provider, which may be the prescribing physician. The service provider owns or leases the equipment used to provide the service. If the services of a consultant are needed to evaluate the results of the service (for example, a radiologist to interpret X-ray or MRI images), the results of the service are referred to the consultant and the consultant issues a report. The consultant provides the report to the original prescribing physician, who delivers and interprets the results for the patient and advises the patient in making appropriate medical decisions.

Where the patient is being evaluated for a claim for compensation by, say, a disability insurer, worker's compensation insurer, government agency or self-insured entity (collectively, “disability payor”), the disability payor may require the patient to undergo examinations to document the patient's claim. The disability payor may refer the patient to a physician. The physician may prescribe appropriate testing. The results of the testing are reported to the physician, who provides a report to the patient for delivery to the disability payor. Alternatively, the physician may provide the report directly to the disability payor.

### BRIEF DESCRIPTION OF THE INVENTION

The invention is a method for providing medical services. A network administrator administers a subscriber network of examination providers each of whom conducts physical examinations of patients. Each examination provider pays a subscription fee, meets other requires for subscription and subscribes to the subscriber network for a predetermined period of time. The conditions for the examination provider to subscribe to the subscriber network include providing a location at which examination equipment may be installed and providing personnel to operate the examination equipment.

During the period of the examination provider's subscription to the subscriber network, the network administrator supplies to the examination provider examination equipment, training and examination protocols necessary to utilize an examination technology in performing the physical examination. The examination equipment and hence the physical examination apply dynamic neuromyography technology. Alternatively, the examination equipment may utilize X-ray imaging, MRI, CAT, electroencephalogram (“EEG”) or electrocardiogram (“EKG”) technology. The examination provider receives a prescription from a prescribing physician and utilizes the provided examination equipment and protocols to perform a physical examination of the patient.

The examination provider collects examination data during the physical examination of the patient. The examination data is digitized and encrypted by the examination equipment and transmitted over a computer network, such as the Internet, to an evaluating entity. The evaluating entity evaluates the examination data using an automated expert system operating under the supervision of a physician. The expert system compares the examination data to a preexisting database of diagnostic conclusions prepared or approved by one or more expert physicians. If the examination data is within the experience of the expert system, the expert system prepares a report indicating the appropriate diagnostic conclusion based on the examination data. If the examination data is anomalous or otherwise not within the experience of the expert system, the expert system refers the examination data to an expert physician for review. The expert physician provides a diagnostic conclusion based on the examination data and the expert physician's diagnostic conclusion is incorporated into the report. The expert system then is supplemented to accommodate the expanded experience reflected by the expert physician's review.

Each of the steps of the evaluation of the examination data and preparation of the report is conducted under the supervision of a physician. Although a physician may not physically review every report generated by the expert system, every report nonetheless presents the expert opinion of a physician. To supervise the system, one or more expert physicians are supplied with a physician's workstation equipped with a CNMP viewer. A CNMP viewer is a software tool for displaying examination data and reports generated by the expert system. All of the raw data and reports are supplied to the expert physician's workstation and are available for review by the expert physician. The expert physician reviews for quality assurance purposes a predetermined proportion of the raw data and the reports resulting from the automated evaluation of the raw data by the expert system.

The evaluating entity provides the report generated by the expert system to the prescribing physician. Where the physical examination is conducted as a part of an investigation of a claim for compensation and where the evaluating entity has a contractual relationship with the payor, the evaluating entity may provide the report directly to the payor. The network administrator and the evaluating entity may be the same entity.

The network administrator submits a global claim for payment to a payor for the combination of a testing fee for the physical examination by the examination provider, a reading fee for the analysis of the resulting data by the evaluating entity, and an administrative fee for maintenance and operation of the subscriber network by the network administrator. The payor makes a combined payment to the network administrator. The network administrator pays the reading fee to the evaluating entity and pays the testing fee to the examination provider. The network administrator retains the administrative fee.

As a first embodiment, the network administrator and the network administrator are separate entities. As a second embodiment, the functions of the network administrator and evaluating entity may be performed by a single system operator. As a third embodiment, the billing and collection functions may be performed by an examination provider. As a fourth embodiment, patient scheduling, billing and disbursement functions may be provided by a broker.

As used in this application, the term “payor” means an entity that is obligated to pay for the physical examination and evaluation of examination data. A “payor” may be a health insurer, government health benefits provider such as Medicare or Medicaid, a self-insured entity, or a patient. The “payor” also may be a disability insurer, workers' compensation insurer or self-insured entity, or a government disability benefits provider such as the Social Security Administration.

The method of the Invention provides several benefits compared to the prior methods. First, the use of the subscriber network of the Invention allows a medical diagnostic equipment supplier that is also an evaluating entity to realize a continuing income stream, rather than realizing a one-time sale or lease of a product. Second, the subscriber network of the Invention allows the examination provider and the system operator to utilize global billing in a manner that is fully compliant with applicable law. Finally, the subscriber network of the Invention allows considerable flexibility in the business relationships among entities providing medical diagnostic services.

### BRIEF DESCRIPTION OF THE DRAWINGS

FIG. 1 is a schematic diagram of the subscriber network of a first embodiment where a system operator comprises a network administrator and a separate evaluating entity.

FIG. 2 is a schematic diagram of the selection of examination equipment.

FIG. 3 is a schematic diagram of information flow (solid lines) and payment flow (dashed lines) among a network administrator, examination provider, the evaluating entity and others where network administrator and the evaluating entity are separate entities and the physical examination is performed for the purpose of providing therapy to the patient.

FIG. 4 is a flow chart of the evaluation of the examination data by the evaluating entity.

FIG. 5 is a schematic diagram of information flow where network administrator and the evaluating entity are separate entities and the physical examination is performed for the purpose of providing therapy to the patient.

FIG. 6 is a schematic diagram of billing and payment flow where network administrator and the evaluating entity are separate entities and the physical examination is performed for the purpose of providing therapy to the patient.

FIG. 7 is a schematic diagram of information flow (solid lines) and billing and payment flow (dashed lines) where network administrator and the evaluating entity are separate entities and the physical examination is performed for the purpose of determining a claim for compensation by the patient.

FIG. 8 is a schematic diagram of information flow where network administrator and the evaluating entity are separate entities and the physical examination is performed for the purpose of determining a claim for compensation by the patient.

FIG. 9 is a schematic diagram of an alternative where the network administrator and the evaluating entity are separate entities and the patient is the payor.

FIG. 10 is a schematic diagram of a second alternative where the network administrator and the evaluating entity are separate entities and the patient is the payor.

FIG. 11 is a schematic diagram of the requirements of the subscriber network where a single system operator performs the functions of the network administrator and the evaluating entity.

FIG. 12 is a schematic diagram of the information flow (solid lines) and the billing and payment flow (dashed lines) in the case of a single system operator where the physical examination is performed for the purpose of providing therapy to the patient.

FIG. 13 is a schematic diagram of the information flow in the case of a single system operator where the physical examination is performed for the purpose of providing therapy to the patient.

FIG. 14 is a schematic diagram of the billing and payment flow in the case of a single system operator where the physical examination is performed for the purpose of providing therapy to the patient.

FIG. 15 is a schematic diagram of information flow (solid lines) and billing and payment flow (dashed lines) in the case of a single system operator where the physical examination is performed for the purpose of determining a claim for compensation by the patient.

FIG. 16 is a schematic diagram of information flow in the case of a single system operator where the physical examination is performed for the purpose of determining a claim for compensation by the patient.

FIG. 17 is a schematic diagram in the case of the single system operator where the examination provider performs billing and payment obligations.

FIG. 18 is a schematic diagram in the case of the single system operator where a broker performs scheduling, billing and disbursement functions.

FIG. 19 is a schematic diagram of a dynamic neuromyography device.

### DESCRIPTION OF AN EMBODIMENT

### A. First Embodiment

### A Network Administrator and an Evaluating Entity are Separate Entities

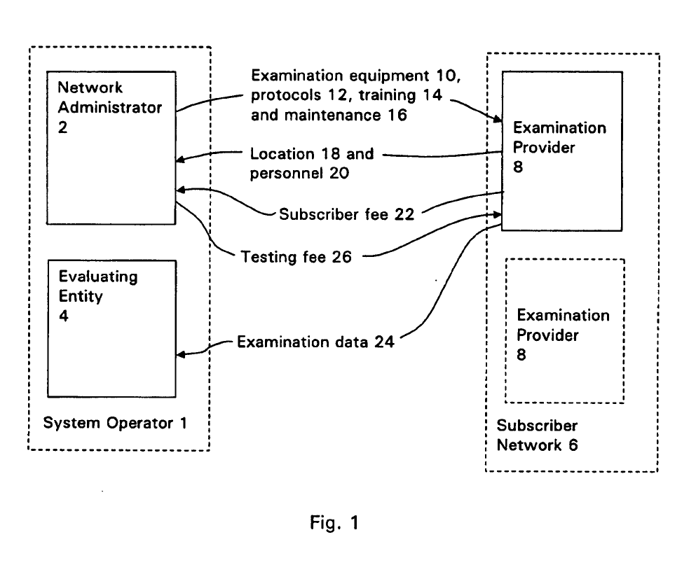

A first embodiment of the method of the Invention is shown by FIGS. 1-10. A system operator 1 is illustrated by FIG. 1. The system operator 1 may be a single entity or may comprise any number of separate entities. Where the system operator comprises more than one separate entity, the separate entities may have any degree of affiliation or may be independent contractors. In the embodiment illustrated by FIG. 1, the system operator 1 comprises two independent entities: a network administrator 2 and an evaluating entity 4.

As shown by FIG. 1, the network administrator 2 administers a subscriber network 6. The subscriber network 6 consists of a plurality of examination providers 8. Each examination provider 8 is the office of a physician, a hospital or other health care provider. Each examination provider 8 applies for membership within the subscriber network 6. Upon satisfaction of the conditions established by the network administrator 2 for membership in the subscriber network 6, the examination provider 8 becomes a member of the subscriber network 6. The examination provider's 8 membership in the subscriber network 6 has a predetermined duration, presently five years.

As a condition of joining the subscriber network 6, the examination provider 8 and the network administrator 2 enter into an agreement. Pursuant to the agreement and as shown by FIG. 1, the network administrator 2 provides to the examination provider 8 substantially all of the examination equipment 10, examination protocols 12, training 14 in the use of the examination equipment 10, required for the examination provider 8 to perform physical examinations using the examination equipment 10 during the duration of the examination provider's 8 subscription to the subscriber network 6. The network administrator 2 also provides all required maintenance 16 and calibration of the examination equipment 10 during the term of the examination provider's 8 membership in the subscriber network 6.

The examination provider 8 supplies an appropriate location 18 for the examination equipment 10 to be installed and also provides personnel 20 to operate the examination equipment 10. The examination provider 8 also pays an initial subscription fee 22 to the network administrator 2. Once the examination provider 8 is a member of the subscriber network 6, the examination provider 8 conducts physical examinations using the examination equipment 10 and transmits the resulting examination data 24 to an evaluating entity 4. The network administrator 2 pays a testing fee 26 to examination provider 8 for every physical examination conducted by the examination provider 8. Upon termination of the examination provider's 8 participation in the subscriber network 6, the examination provider 8 will surrender possession of the examination equipment 10 to the network administrator 2 and the network administrator 2 will provide no more protocols 12, training 14 or maintenance 16 to the examination provider 8.

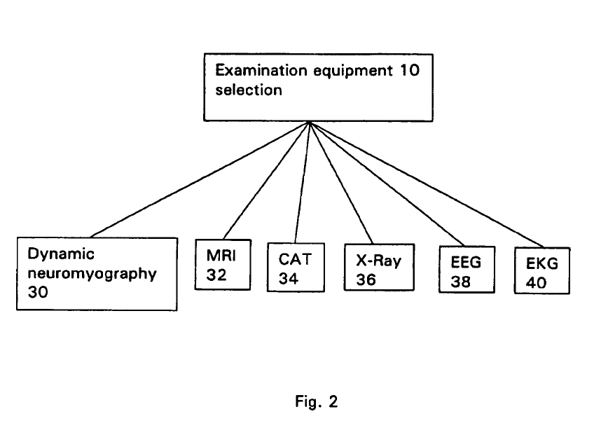

As shown by FIG. 2, the examination equipment 10 may be selected from any equipment required to collect information relating to a patient 28. The Invention is most directly applicable to examination equipment 10 where a significant obstacle to acquisition and use of the examination equipment 10 by potential examination providers 8 exists, such as instances where access to the examination equipment 10 is limited by patent protection, by high cost or by the need for expert interpretation. The Invention has specific applicability to dynamic neuromyography technology 30, but also may be applicable to MRI 32, CAT 34, X-ray 36, EEG 38 and EKG 40 technologies.

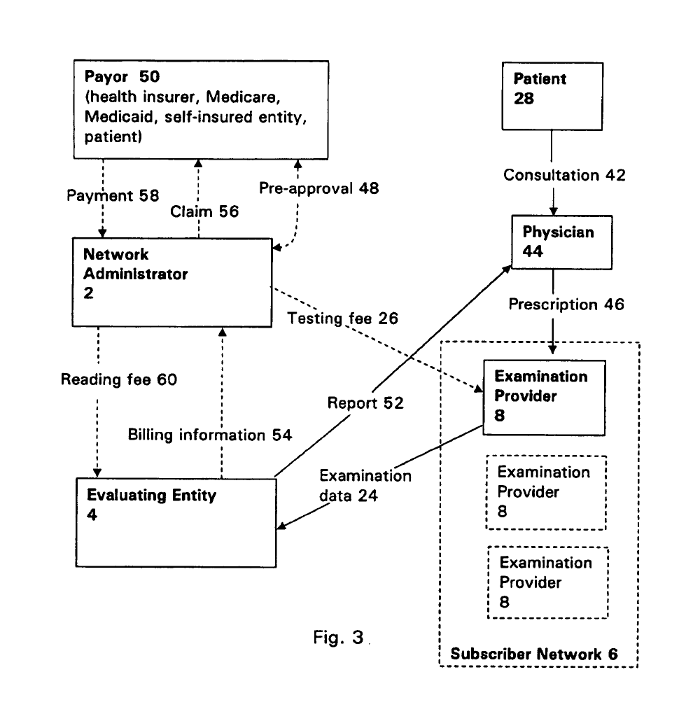

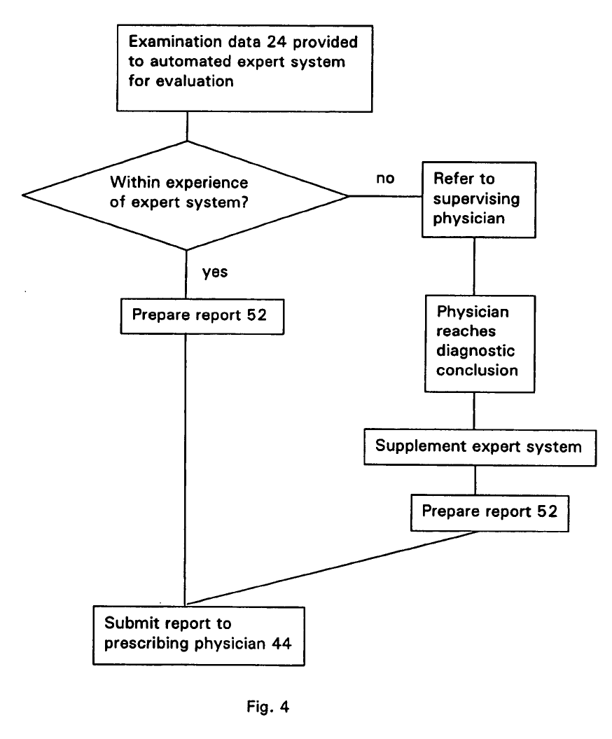

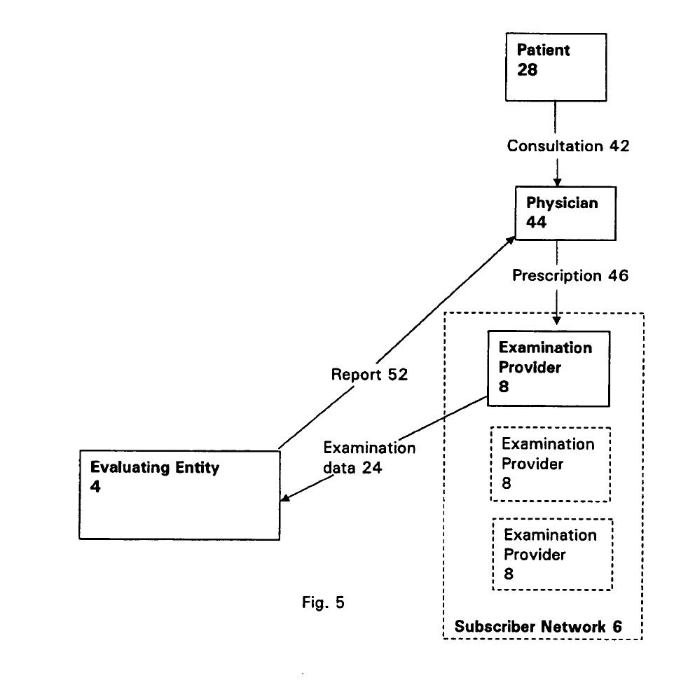

FIGS. 3-6 show a first application of the first embodiment of the invention where the network administrator 2 and the evaluating entity 4 are separate entities and the Invention is used to evaluate the health of a patient 28 for therapeutic purposes. FIG. 3 illustrates both the flow of information and the flow of billing and payment for this first application. FIG. 4 illustrates only the flow of information and FIG. 5 illustrates only the flow of billing and payment for this first application.

As shown by FIGS. 3 and 5, the patient 28 consults 42 with a prescribing physician 44 about a health issue. The prescribing physician 44 issues a prescription 46 that the patient 28 obtain a physical examination using a specified examination technology 30 through 40. For purposes of example, this application assumes that the prescribing physician 44 has prescribed that the patient 28 be examined using dynamic neuromyography technology 30.

The patient 28 or the prescribing physician 44 schedules an appointment for a physical examination. The patient 28 or prescribing physician 44 telephones a call center or accesses an Internet web site operated by the network administrator 2. The network administrator 2 obtains pre-approval 48 for the examination from a payor 50. In this case, the payor 50 is a health insurer, medical benefits payor or self-insured entity. The network administrator 2 schedules the examination with an examination provider 8 and notifies the examination provider 8, the patient 28 or prescribing physician 44.

In each of the embodiments listed in this application, the prescribing physician 44 may be affiliated with the examination provider 8. In that event, the prescribing physician 44 or patient 28 may schedule the physical examination directly with the examination provider 8.

The examination provider 8 conducts the prescribed physical examination of the patient 28 using the examination equipment 10. The examination equipment 10 collects examination data 24 during the patient 28 examination. The examination data 24 presents the measurements of patient 28 response to the physical examination. The examination data 24 is digitized, encrypted and transmitted by the examination equipment 10 to the evaluating entity 4 over a computer network, such as the Internet. Any other means for transferring the examination data 24 from the examination provider 8 to the evaluating entity 4 also is contemplated. The examination data 24 may be digitized and recorded on electronic media, such as a compact disk, DVD, floppy disk or other removable media. The electronic media may then be physically transported to the evaluating entity 4. The examination data 24 may be given physical form, as by recording the examination data 24 using indicia appearing on paper, and transporting the paper including the examination data 24 to the evaluating entity 4. The examination data 24 may be transmitted using an auditory signal, such as a telephone or other verbal communication. The examination data 24 may be transmitted by a radiant signal, such as radio, light or electromagnetic radiation. The examination data 24 may be transmitted over a cable, such as a wire or optical cable.

As shown by FIG. 4, the evaluating entity 4 receives the examination data 24 and evaluates the examination data 24 using an automated expert system. In the case of dynamic neuromyography 30 technology and as described in U.S. patent application Ser. No. 10/504,031, the automated expert system evaluates the examination data 24 to detect patterns in the examination data 24 and to compare the examination data 24 and the patterns detected with an expert database. If the patterns detected are within the experience of the expert system, the expert system associates a diagnostic conclusion with the patterns detected and the examination data 24 and prepares a report 52. A physician supervises the operation of the automated expert system. The report 52 generated by the automated expert system presents the physician's professional opinion based on the examination data 24. The evaluating entity 4 transmits the report 52 to the prescribing physician 44. The prescribing physician 44 uses the information contained in the report 52 to design a treatment program for the patient 28.

The automated expert system utilized by the evaluating entity 4 is programmed to recognize patterns in the examination data 24 that are not within the experience of the expert system. When the expert system detects examination data 24 presenting such a pattern, the expert system will alert a supervising physician. The supervising physician will review the examination data 24 and render a professional opinion based on the examination data 24. The supervising physician will cause the expert system to be supplemented so that when the expert system is presented with the new pattern in the examination data 24 in the future, the expert system will recognize the pattern and prepare a report 52 including the appropriate diagnostic conclusions.

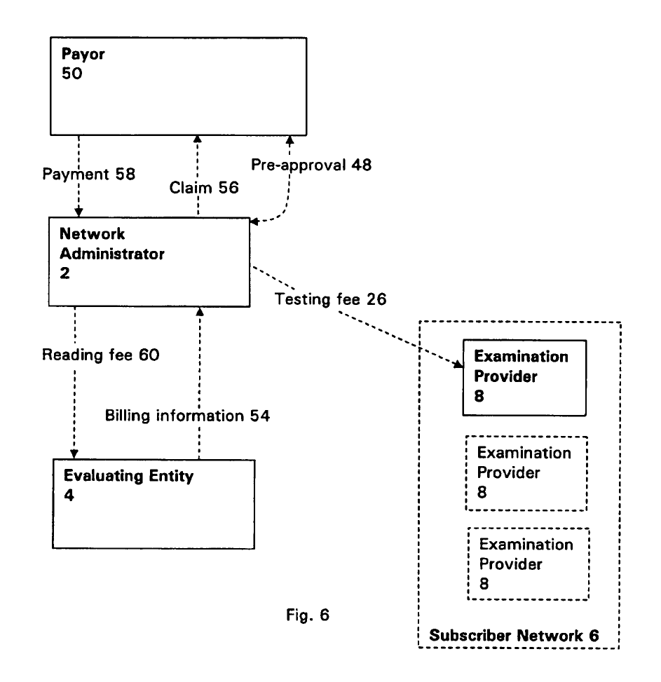

FIG. 6 illustrates billing and payment where the network administrator 2 and the evaluating entity 4 are separate entities. The examination provider 8 obtains pre-approval 48 from a payor 50 for payment for the physical examination by the examination provider 8 and for the evaluation of the examination data 24 by the evaluating entity 4. The examination provider 8 does not perform the physical examination until the pre-approval 48 has been granted. The evaluating entity 4 submits billing information 54 to the network provider 2, which in turn submits a claim 56 to the payor 50. The claim 56 addresses three components: a testing fee 26 to pay for the administration of the physical examination by the examination provider 8, a reading fee 60 to pay for the evaluation of the examination data 24 by the evaluating entity 4, and an administrative fee 63 to compensate the network administrator 2 for operating the subscriber network 6. Where the physical examination is prescribed for the purpose of providing therapy to the patient 28, the payor 50 is likely to be a health insurer, Medicare, Medicaid or a self-insured entity, such as a business.

The payor 50 makes payment 58 to the network administrator 2. The network administrator 2 makes the testing fee 26 payment to the examination provider 8 and the reading fee 60 payment to the evaluating entity 4. The network administrator 2 retains the administrative fee 63.

For each of the embodiments discussed in this application, the functions of the network administrator 2 or the evaluating entity 4 may be divided among two or more entities. For example, the functions of the network administrator 2 to accept examination providers 8 into the subscriber network 6 and to provide equipment 10, protocols 12, training 14 and maintenance 16 for the conduct of physical examinations may be provide by a first. The functions of the network administrator 2 to schedule examinations, submit claims 56 to payors 50, receive payments 58 and disburse testing fees 26 and reading fees 60 may be provided by another entity.

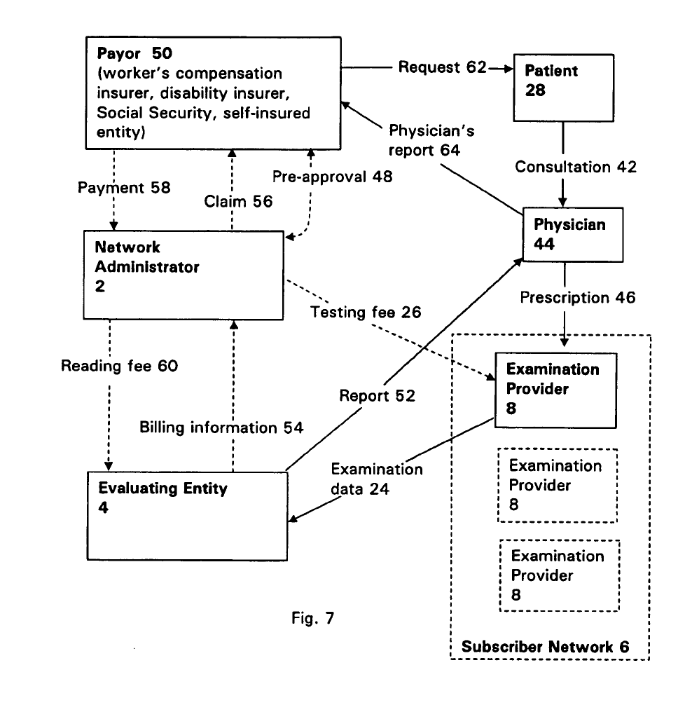

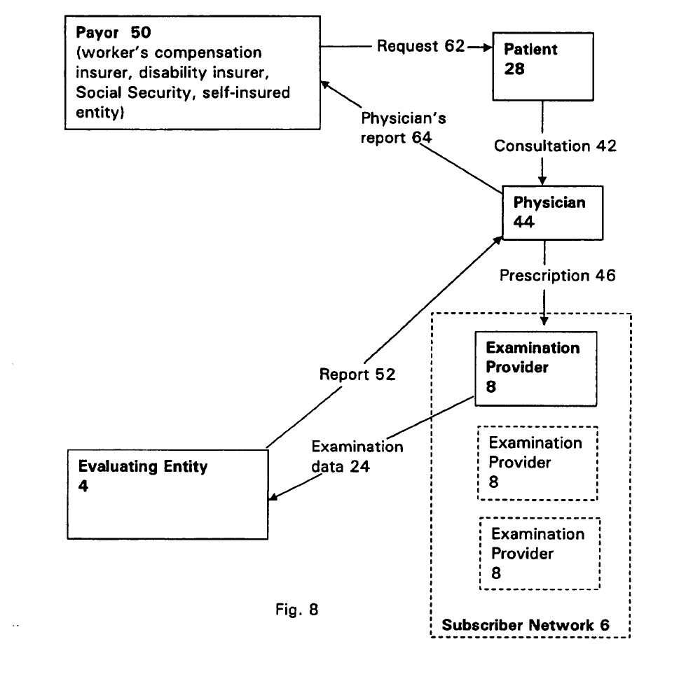

FIGS. 7 and 8 present a second application of the first embodiment of the Invention; namely, where the network administrator 2 and the evaluating entity 4 are separate entities and the purpose of the physical examination is to evaluate a claim for compensation, such as disability compensation. FIG. 7 presents a both the information flow and payment flow in a single figure. FIG. 8 presents the information flow in isolation.

From FIGS. 7 and 8, a payor 50 such as a disability insurer wishes to investigate a claim for disability compensation by a patient 28. The payor 50 will submit a request 62 to the patient 28 that the patient 28 obtain a dynamic neuromyography 30 examination as a condition to approving the claim for compensation. The patient 28 will consult 42 with a physician 44. The physician 44 will prepare a prescription 46 for the dynamic neuromyography 30 physical examination.

The patient 28, prescribing physician 44 or the payor 50 schedules an appointment for a physical examination. The patient 28, prescribing physician 44 or payor 50 telephones a call center or accesses an Internet web site operated by the network administrator 2. Pre-authorization 48 may not be required where the payor 50 schedules the physical examination. The network administrator 2 schedules the examination with an examination provider 8 and notifies the examination provider 8, the patient 28 or prescribing physician 44.

The examination provider 8 will conduct a dynamic neuromyography 30 physical examination of the patient 28 utilizing the examination equipment 10. The examination equipment will collect examination data 24 as a result of the physical examination. The examination provider 8 will transmit the examination data 24 to the evaluating entity 4. The evaluating entity 4 will prepare a report 52 including a physician's professional opinion utilizing the automated expert system, as described above. The evaluating entity 4 will submit the report 52 to the prescribing physician 44. The prescribing physician 44 will include the results of the report 52 in a physician's report 64 to the payor 50. A payor 50 may have contractual relationships with the network administrator 2 or the evaluating entity 4 allowing the report 52 generated by the evaluating entity 4 to be transmitted directly to the payor 50.

The payment flow for the second application, where the network administrator 2 and the evaluating entity 4 are separate entities and the purpose of the physical examination is to evaluate a claim for disability compensation by the patient 28, is as shown by FIG. 6 and as described above relating to that figure.

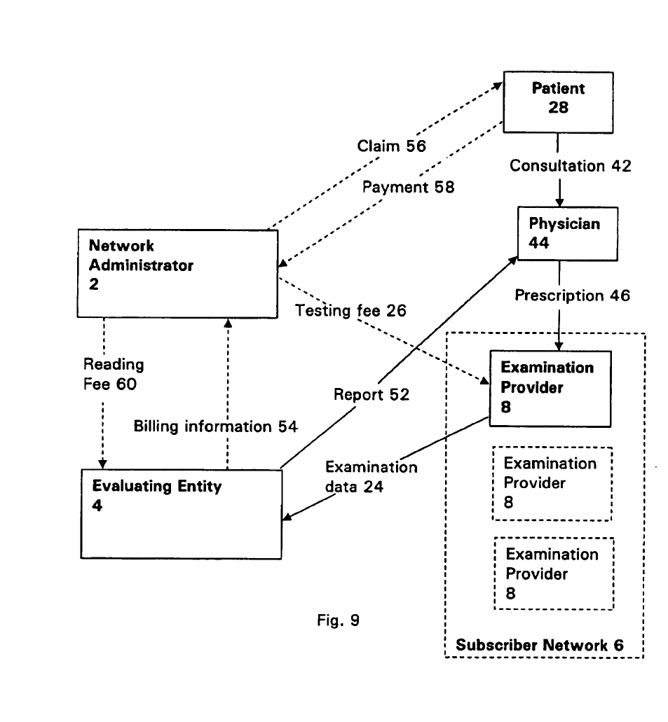

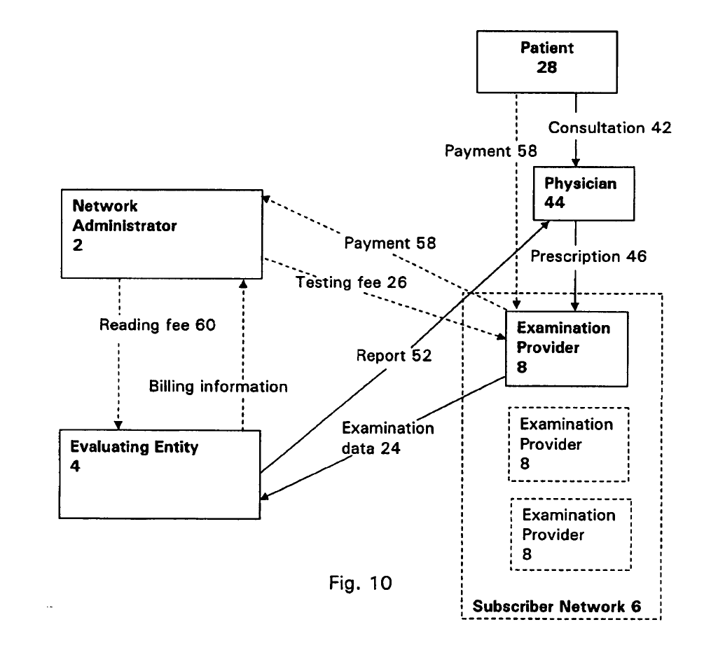

FIGS. 9 and 10 present a third application of the first embodiment of the Invention where the network administrator 2 and the evaluating entity 4 are separate entities and the patient 28 is the payor 50. FIG. 9 presents the situation where the network administrator 2 makes a claim for payment for the testing fee 26, reading fee 60 and administrative fee 63 to the patient 28 and the patient 28 makes the payment to the network administrator 2. Pre-approval 48 by the patient 28 optionally may be required. The payment flow is otherwise as shown by FIG. 6.

FIG. 10 presents the situation where the patient 28 makes the payment for the testing fee 26, reading fee 60 and administrative fee 63 to the examination provider 8. The examination provider 8 then forwards that payment to the network administrator 2. The network administrator 2 returns the testing fee 26 to the examination provider 8 and pays the reading fee 60 to the evaluating entity 4. The network administrator 2 retains the administrative fee 63.

### B. Second Embodiment

### The Network Administrator and the Evaluating Entity are a Single Entity

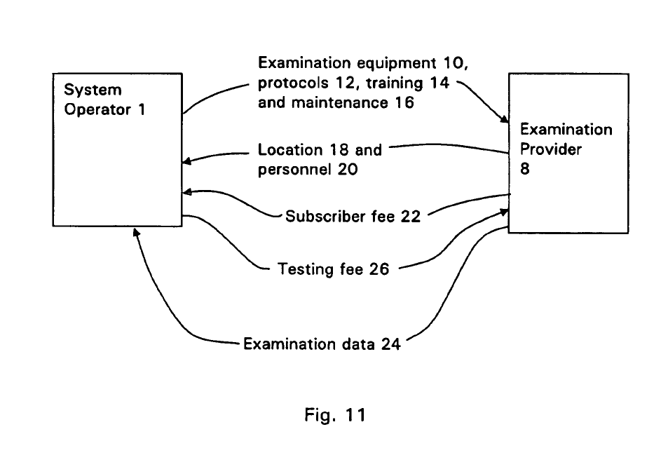

FIGS. 11-16 illustrate a second embodiment where the system operator 1 is a single entity. As shown by FIG. 11, the system operator 1 provides the selected examination equipment 10. The system operator 1 also supplies protocols 12, training 14 and maintenance 16 to allow proper operation of the examination equipment 10. The examination provider 8 provides a location 18 for installation of the equipment 10 and personnel 20 to operate the equipment 10. The examination provider 8 pays a subscriber fee 22 to the system operator 1. The examination provider 8 conducts physical examinations of patients 28 and submits the examination data 24 to the system operator 1. The system operator 1 pays the testing fee 26 received from the payor 50 to the examination provider 8.

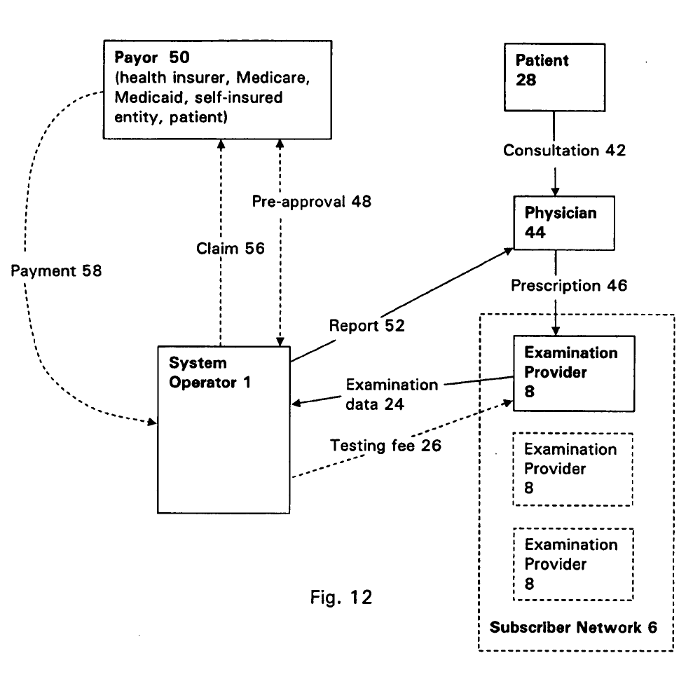

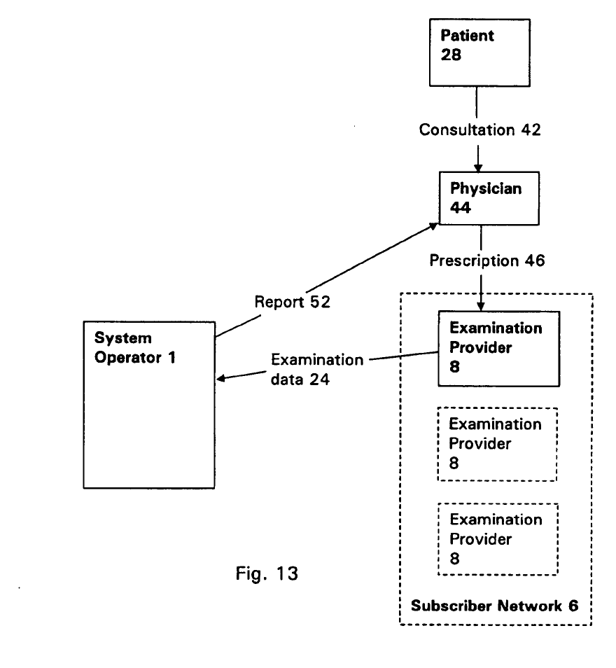

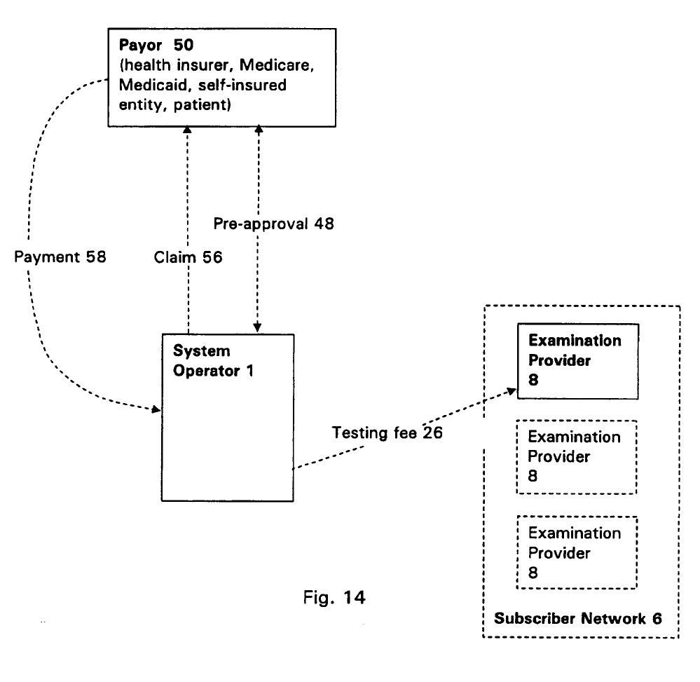

FIGS. 12-14 illustrate a first application of the second embodiment of the Invention where the system operator 1 is a single entity and the Invention is used to administer medical services to evaluate the health of a patient 28 for therapeutic purposes. FIG. 12 shows in a single figure both the information flow relating to the physical examination of the patient 28 and also shows the system of billing and payment. FIG. 13 shows only the information flow where the examination is conducted for therapeutic purposes. FIG. 14 shows only the system of billing and payment where the examination is conducted for therapeutic purposes.

As shown by FIGS. 12 and 13, the patient 28 consults 42 his or her physician 44 with a health complaint. The physician 44 determines that a physical examination, such as an examination using dynamic neuromyography 30 technology, would be useful in determining a course of treatment for the patient 28. The physician 44 writes a prescription 46 for the dynamic neuromyography 30 physical examination.

The patient 28 or prescribing physician 44 schedules an appointment for a physical examination. The patient 28 or prescribing physician 44 telephones a call center or accesses an Internet web site operated by the system operator 1. The system operator 1 obtains pre-approval 48 for the examination from a payor 50. In this case, the payor 50 is a health insurer, medical benefits payor or self-insured entity. The system operator 1 schedules the examination with an examination provider 8 and notifies the patient 28 or prescribing physician 44. The examination provider 8 conducts the examination of the patient 28 using the examination equipment 10.

The examination equipment 10 generates examination data 24 during the physical examination. The examination provider 8 transmits the examination data 24 over a computer network such as the Internet to the system operator 1. The system operator 1 applies an automated expert system to the examination data 24 and generates a report 52. The report 52 includes the diagnostic conclusions generated by the expert system and represents the professional opinion of a physician supervising the automated expert system. The system operator 1 transmits the report 52 to the prescribing physician 44. The prescribing physician 44 uses the information contained in the report 52 to design a treatment program for the patient 28.

FIGS. 12 and 14 illustrate the system of billing and payment of the invention where the system operator 1 is a single entity and the physical examination is for the purpose of providing a therapeutic benefit to the patient 28. Before the examination provider 8 conducts the physical examination of the patient 28, the system operator 1 contacts the payor 50 and obtains a pre-approval 48 of the physical examination. The payor 50 is a health insurer, government health benefit provider such as Medicare or Medicaid, self-insured entity, or the patient 28. The pre-approval 48 provides assurance that the system operator 1 and the examination provider 8 will be compensated for the physical examination, evaluation of the examination data 24 and generation of the report.

As shown by FIG. 12, after the generation and transmission of the report 52 by the system operator 1, the system operator 1 submits a claim 56 to the payor 50. The claim 56 addresses three components: the testing fee 26 relating the physical examination of patient 28 by the examination provider 8, the reading fee 60 relating to the evaluation of the examination data 24 by the system operator 1, and the administrative fee 63 relating to operation of the subscriber network by the system operator 1. The payor 50 makes payment 58 to the system operator 1. The system operator 1 pays the testing fee 26 to the examination provider 8. The system operator 1 retains the reading fee 60 and administrative fee 63.

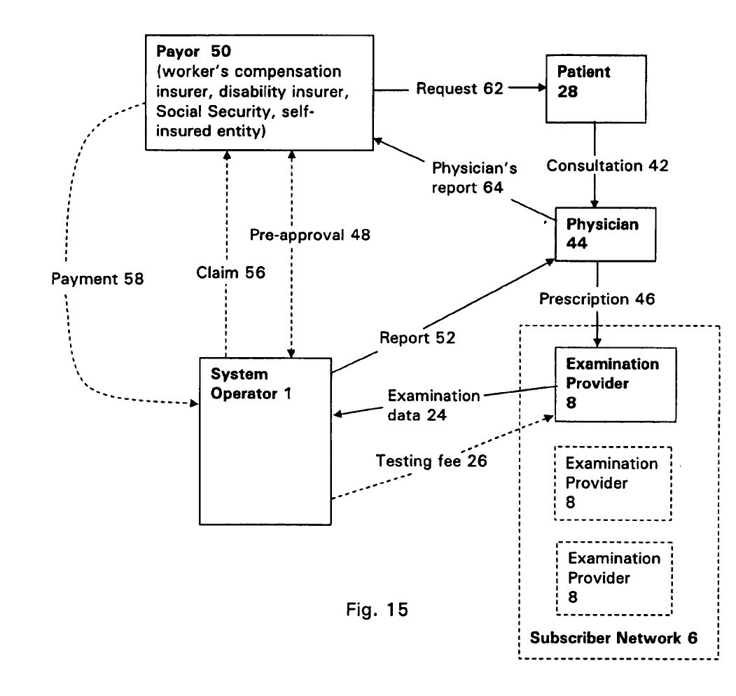

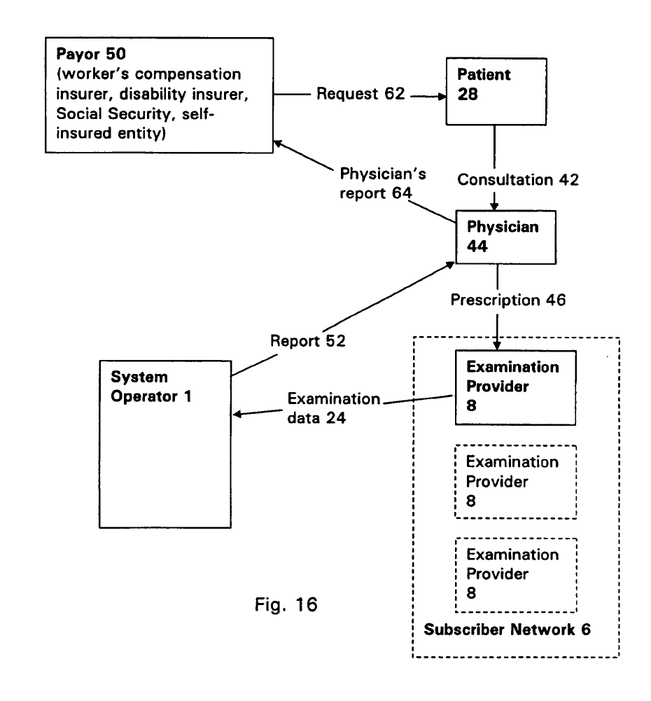

FIGS. 15 and 16 illustrate a second application of the second embodiment of the Invention where the system operator 1 is a single entity and the patient 28 is required to undergo a physical examination by a payor 50 to evaluate a compensation claim made by the patient 28. FIG. 15 shows in a single figure both the information flow relating to the physical examination and also shows the system of billing and payment. FIG. 16 illustrates a portion of the information shown on FIG. 15 and shows only the information flow relating to the physical examination. The payor 50 in this instance is a worker's compensation insurer, disability insurer, government disability benefits provider such as the Social Security Administration, or self insured entity. The nature of the claim for compensation by the patient 28 is a claim for a medical disability.

As shown by FIG. 16 illustrating information flow for the physical examination, the payor 50 requests a patient 28 to secure a physical examination using a specified technology, such as dynamic neuromyography 30 technology. The patient 28 consults 42 a prescribing physician 44, who issues a prescription 46 for a physical examination using the specified dynamic neuromyography 30 technology.

The patient 28, prescribing physician 44 or the payor 50 schedules an appointment for a physical examination. The patient 28, prescribing physician 44 or payor 50 telephones a call center or accesses an Internet web site operated by the system operator 1. Pre-authorization 48 may not be required where the payor 50 schedules the physical examination. The system operator 1 schedules the examination with an examination provider 8 and notifies the examination provider 8, the patient 28 or prescribing physician 44. The selected examination provider 8 performs the physical examination using the examination equipment 10.

The examination equipment 10 generates examination data 24 during the physical examination. The examination provider 8 transmits the examination data 24 over a computer network such as the Internet to the system operator 1. The system operator 1 evaluates the examination data 24 using the automated, expert system. The system operator 1 generates a report 52 evaluating the examination data 24 and presenting diagnostic conclusions based on the examination data 24. The report 52 represents the professional opinion of a physician supervising the automated expert system. The system operator 1 transmits the report 52 to the prescribing physician 44. The prescribing physician 44 then transmits a physician's report 64 to the payor. The payor 50 uses the information in the physician's report 64 in determining the claim for compensation by the patient 28. Where appropriate arrangements have been made, the system operator 1 may transmit its report 52 directly to the payor 50.

The system of billing and payment where system operator 1 is a single entity is presented by FIG. 14 and as discussed above relating to that figure. The difference between the situations where the Invention is utilized for therapeutic purposes and where the Invention is used to evaluate a disability claim resides in the identity of the payor 50. Where the Invention is used to evaluate a disability claim, the payor 50 is a workers compensation insurer, disability insurer, government payor such as the Social Security Administration, or self insured entity. Where the Invention is used for therapeutic purposes, the payor 50 is a health insurer, a government health payor such as Medicare or Medicaid, a self-insured entity or a patient 28.

### C. Third Embodiment

### The Examination Provider Performs Billing, Collection and Disbursement Functions

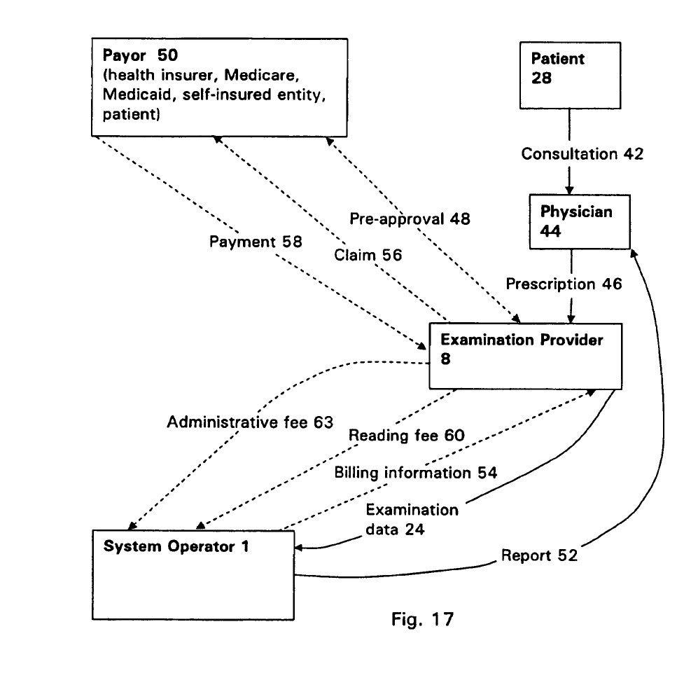

FIG. 17 illustrates a third embodiment of the Invention where certain billing, collection and disbursement functions are performed by the examination provider 8. As illustrated by FIG. 17, the examination provider 8 subscribes to the subscriber network 6 by committing to a system operator 1 to provide a location 18 for examination equipment 10 to be installed, by providing personnel 20 to operate the equipment and by paying a subscriber fee 22, as illustrated by FIG. 11. In a departure from FIG. 11, the examination provider 8 further commits to submit claims 56 to payors 50, to receive payments 58 from the payors 50 and to pay the reading fee 60 and administrative fee 63 to the system operator 1.

From FIG. 17, the examination provider 8 conducts a physical examination of a patient 28 upon receiving a prescription 46 and obtaining pre-approval 48 from a payor 50. The examination provider 8 uses examination equipment 10 to perform the physical examination and generates examination data 24 during the process. The examination provider 8 transmits the examination data 24 to the system operator 1, which evaluates the data using the automated expert system. The system operator 1 generates a report 52 of diagnostic conclusions based on the examination data 24 and transmits the report 52 to the prescribing physician 44.

The system operator 1 provides billing information 54 to the examination provider 8 relating to the service rendered by the system operator 1. The examination provider 8 makes a claim 56 to the payor 50. The claim 56 addresses the testing fee 26 for the conduct of the physical examination by the examination provider 8, the reading fee 60 for the evaluation of the examination data 24 by the system operator 1, and the administrative fee 63 for operation of the subscriber network by the system operator 1. The examination provider 8 receives payment 58 from the payor 50 and forwards the reading fee 60 and administrative fee 63 to the system operator 1. The examination provider 8 retains the testing fee 26.

### D. Fourth Embodiment

### A Broker Provides Scheduling, Billing and Disbursement Functions

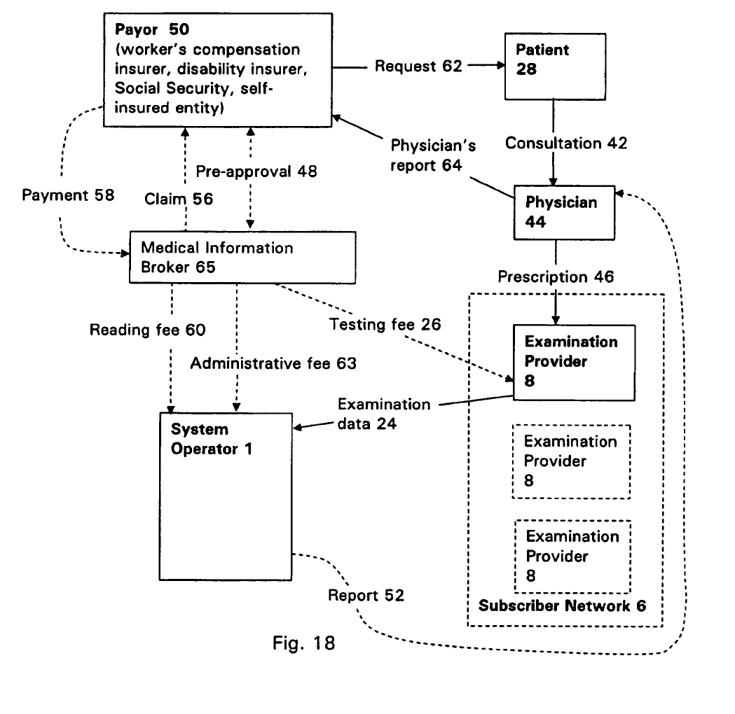

FIG. 18 illustrates an embodiment where a broker 65 performs scheduling, billing and disbursement functions. In the example illustrated by FIG. 18, a payor submits a request 62 to a patient 28 that the patient 28 obtain a physical examination using dynamic neuromyography 30 to evaluate a claim for compensation by the patient 28. The patient consults 42 with a prescribing physician 44. The prescribing physician prescribes dynamic neuromyography 30. The prescribing physician 44, the patient 28 or the payor 50 contacts a broker 65 to schedule the physical examination. The broker 65 secures pre-approval 48 from the payor 50 and schedules the physical examination with an examination provider 8. The examination provider 8 conducts the physical examination and transmits the resulting examination data 24 to the system operator 1. The system operator 1 evaluates the examination data 24 using an automated expert system. The system operator generates a report 52. The system operator 1 provides the report to the prescribing physician 44.

The broker 65 submits a claim 56 for payment to the payor 50. The claim 56 for payment includes a testing fee for the conduct of the physical examination by the examination provider 8, a reading fee 60 for the evaluation of the examination data 24 by the system operator 1, and an administrative fee 63 for operation of the subscriber network by the system operator 1. The broker 65 receives payment 58 from the payor 50. The broker 65 pays the reading fee 60 and the administrative fee 63 to the system operator 1 and the testing fee 26 to the examination provider 8.

The subscriber network 6 is administered for this fourth embodiment as shown by FIG. 11 and as discussed above relating to that figure.

### E. Dynamic Neuromyography

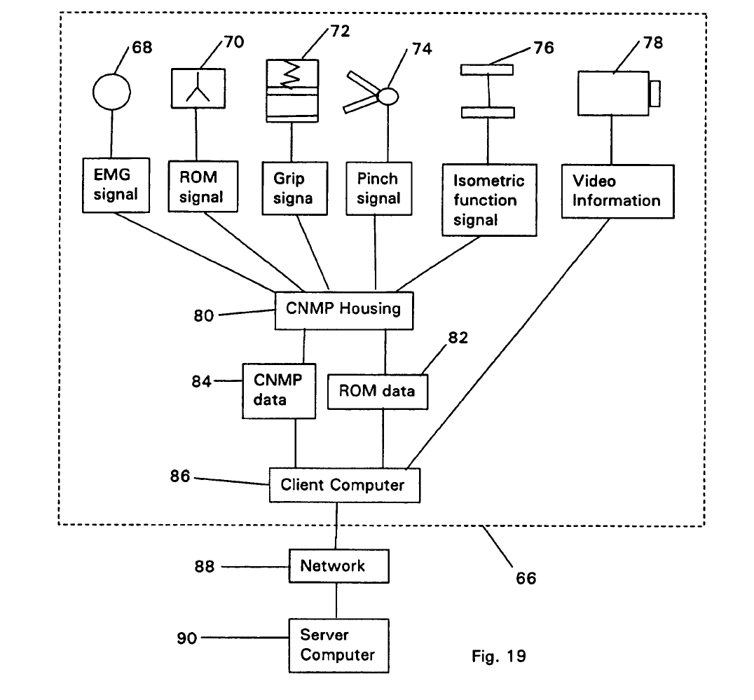

The Invention is particularly useful in the administration of physical examinations using dynamic neuromyography 30 technology, as disclosed in U.S. patent application Ser. No. 10/504,031 and illustrated by FIG. 19, which is drawn from FIG. 1 of the referenced application. Dynamic neuromyography 30 technology integrates several muscle and joint monitoring measurements into a single apparatus 66 so that an expert diagnosis may be provided based on the data collected by the apparatus 66. The dynamic neuromyography apparatus 66 gathers multiple types of information, which may be collected simultaneously or serially, including motion, muscle capacity, electromyography (“EMG”) and video images.

EMG measurements are collected by attaching electrodes 68 to the patient 28 and recording electrical activity of the muscles in question.

Dynamic neuromyography technology range-of-motion (“ROM”) data are collected by remote sensors 70. A suitable technology is pulsed DC magnetic field sensing, although other sensing technologies such as optical sensing or AC magnetic field sensing may be used. In pulsed DC magnetic field sensing, an electromagnetic transmitter generates a pulsed electromagnetic field. ROM sensors are attached to the patient 28. Changes in the electromagnetic field are detected by the ROM sensors 70 and are measured and analyzed by a ROM signal processor, which translates the ROM signal from the ROM sensors into ROM data defining the position and motion of the ROM sensors and hence of the patient 28. The motions measured may include the dynamic motion of the patient 28 within the ROM.

Grip strength measurements and finger pinch strength measurements are made by having the patient 28 grip or pinch appropriate grip and pinch sensors 72, 74. Dynamic neuromyography 30 technology isometric function measurements are collected by having the patient 28 isometrically exert force using the muscle in question against an object and measuring the force exerted by the muscle using a force sensor 76.

A video camera 78 records the physical examination. The video information collected during a physical examination allows medical personnel to remotely monitor the procedure and creates a visual record of the tests performed and the patient's 28 response to the tests.

The signals collected from the EMG sensors, grip sensor, pinch sensor, and isometric function sensor are digitized and encrypted within the CNMP housing 80 as CNMP data 84. The CNMP data 84, ROM data 82 and video information are recorded in the memory of a client computer 86 as examination data 24. The client computer 86 encrypts the examination data 24 and communicates the examination data 24 to a server computer 90 operated by an evaluating entity 4 over a computer network 88, such as the Internet. The examination data 24 automatically in encrypted by the client computer 86 and is not available to the examination provider 8 in unencrypted form. Software resident in the server computer 90 includes an expert system that evaluates the examination data 24 for patterns and for combinations of patterns among the types of data collected. The server computer 90 is programmed to compare the patterns, or lack of patterns, detected in the examination data 24 to predetermined patterns associated with injuries, pathologies, and lack of injuries and pathologies. The expert system may diagnose, for example, sprains, strains, vertebral disk injury and radiculopathies. The expert system also may determine whether the injury is of recent origin, thereby distinguishing acute from chronic injury. The expert system may look for changes in other muscles or behaviors compensating for pain or loss of use as the result of pathology or injury. The server computer 90 assigns a patient 28 profile to the patient 28 based on the diagnosis made by the server computer 90. The server computer 90 communicates the patient 28 profile to the prescribing physician 44 as a report 52.

The client computer 86 is programmed to administer any of several “protocols” 12 to the patient 28 and to record the resulting data. A “protocol” 12 is a sequence of tasks, or tests, that the patient 28 performs while the appropriate sensors collect data concerning the portion of the patient's 28 body in question. Each protocol 12 specifies the identity, number and location of the sensors to be used. The client computer 86 is programmed to provide step-by-step instructions to the patient 28 and to the technician administering the protocol 12 to the patient 28. The dynamic neuromyography technology apparatus 66 may provide automated, interactive instructions to an operator who has no or little knowledge of anatomy. The client computer 86 is programmed to collect and record the appropriate sensor data for each protocol.

As used in this application, the term “client computer” means any computer or system of computers capable of communicating with another computer over a computer network. The term “server computer” means any computer or system of computers that is capable of receiving a communication over a computer network, such as the Internet, from a client computer and performing an evaluation based on the received communication.

As used in the claims of this application, the phrase “as a benefit for subscribing to the subscriber network” means that the benefit is conferred on the examination provider 8 subject to satisfaction by the examination provider 8 of the conditions for such subscription and the benefit terminates upon termination of the examination provider's subscription to the subscriber network 6.

Physical examinations of a patient 28 by an examination provider 8 may be conducted at any location, including without limitation at a home or business of patient 28.

In describing the above embodiments of the invention, specific terminology was selected for the sake of clarity. However, the invention is not intended to be limited to the specific terms so selected, and it is to be understood that each specific term includes all technical equivalents that operate in a similar manner to accomplish a similar purpose.

I claim:

1. A method for administering medical diagnostic services, the method comprising:
a. allowing by a system operator for an examination provider to subscribe to a subscriber network for a period of time upon satisfaction by said examination provider of a condition;
b. providing of examination equipment by said system operator to said examination provider as a benefit for subscribing to said subscriber network;
c. receiving by said system operator from said examination provider of examination data resulting from a physical examination of a patient using said examination equipment;
d. evaluating by said system operator of said examination data using an evaluation technology.

2. The method of claim 1 wherein said examination equipment is selected from the list consisting of a dynamic neuromyography, an X-ray imaging device, an MRI imaging device, a CAT imaging device, an EEG and an EKG.

3. The method of claim 2 wherein said condition for subscribing to said subscriber network satisfied by said examination provider comprises:
a. providing a location for installation of said equipment;
b. providing a personnel to operate said equipment.

4. The method of claim 3, further comprising:
a. providing by said system operator to said examination provider of a training in a use of said equipment;
b. providing by said system operator to said examination provider of a protocol in said use of said equipment;
c. providing by said system operator to said examination provider of a maintenance of said examination equipment;
d. said training, said protocol and said maintenance being provided by said system operator during said period of time of said subscription by said examination provider to said subscriber network.

5. The method of claim 4 wherein said evaluation technology comprises an automated expert system, said evaluation of said examination data using said evaluation technology resulting in a diagnostic conclusion.

6. The method of claim 5, the method further comprising: reporting by said system operator of said diagnostic conclusion to a prescribing physician.

7. The method of claim 6 wherein said system operator comprises an evaluating entity, said steps performed by said evaluating entity comprise: said step of receiving said examination data; said step of evaluating said examination data; and said step of reporting said diagnostic conclusion to said prescribing physician.

8. The method if claim 7 wherein said step of receiving said examination data comprises means for receiving said examination data, said means for receiving said examination data being selected from the list consisting of: receiving said examination data over a computer network, receiving said examination data appearing on a paper, receiving of electronic media containing said examination data, receiving said examination data by an auditory information, receiving said examination data over a cable, and receiving said examination data utilizing radio.

9. The method of claim 8 wherein said system operator further comprises a network administrator, said steps performed by said network administrator comprise: said step of allowing said examination provider to subscribe to said subscriber network, said step of providing said examination provider with said examination equipment, and said steps of providing said training, said protocol and said maintenance.

10. The method of claim 9, the method further comprising:
a. scheduling by said network administrator of said physical examination of said patient by said examination provider.
b. submitting by said network administrator to a payor of a claim for a payment of a testing fee for said physical examination and for a payment of a reading fee for said evaluation of said examination data;
c. receiving by said network administrator of said payments from said payor;
d. paying by said network administrator of said testing fee to said examination provider.

11. The method of claim 9, the method further comprising:
a. scheduling by said examination provider of said physical examination of said patient by said examination provider;
b. submitting by said examination provider to a payor of a claim for a payment for a testing fee for said physical examination and for a payment of a reading fee for said evaluation of said examination data;
c. receiving by said examination provider of said payments from said payor;
d. paying said reading fee to said evaluating entity.

12. The method of claim 9, the method further comprising:
a. scheduling by a broker of said physical examination of said patient by said examination provider;
b. submitting by said broker to a payor of a claim for a payment for a testing fee for said physical examination and for a payment of a reading fee for said evaluation of said examination data;
c. receiving by said broker of said payments from said payor;
d. paying by said broker of said reading fee to said evaluating entity.
e. paying by said broker of said testing fee to said examination provider.

13. A method of providing medical diagnostic services by a network administrator, the method comprising:
a. Providing by the network administrator of a subscriber network;
b. Allowing by the network administrator of an examination provider to subscribe to said subscriber network upon satisfaction by said examination provider of a condition;
c. Providing by the network administrator of an examination equipment to said examination provider as a benefit for subscribing to said subscriber network;
d. Submitting by the network administrator of a claim for a payment to a payor, said payment comprising a testing fee for a conduct of a physical examination of a patient by said examination provider utilizing said examination equipment, said payment further comprising a reading fee for an evaluation by an evaluating entity of an examination data generated using said examination equipment during said physical examination;
f. Receiving by the network administrator of said payment from said payor;
g. Paying by the network administrator of said testing fee to said examination provider for performing said physical examination;
h. Paying by the network administrator of said reading fee to said evaluating entity for said evaluation of said examination data by said evaluating entity.

14. The method of claim 13 wherein said examination equipment is selected from the list consisting of dynamic neuromyography, X-ray, MRI, CAT, EEG and EKG equipment.

15. The method of claim 14 wherein said evaluation of said examination data by said evaluating entity comprises performing by said evaluating entity of an automated analysis by an expert system of said examination data.

16. The method of claim 15, further comprising: providing by the network administrator to said examination provider of training and protocols for operation of said examination equipment as a benefit for subscribing to said subscriber network.

17. The method of claim 16 wherein said condition for allowing said examination provider to subscribe to said subscriber network comprises said examination provider supplying a location for installation of said examination equipment and further comprises said examination provider providing personnel to operate said examination equipment.

18. The method of claim 17 wherein said condition for allowing said examination provider to subscribe to said subscriber network further comprises: receiving by the network administrator of a subscription fee paid by said examination provider.

19. The method of claim 18 wherein said examination equipment is adapted to generate said examination data as a result of said physical examination and wherein said evaluating entity receives said examination data using means for receiving said examination data.

20. The method if claim 19 wherein said means for receiving said examination data is selected from the list consisting of: receiving said examination data over a computer network, receiving said examination data appearing on a paper, receiving of electronic media containing said examination data, receiving said examination data by an auditory information, receiving said examination data over a cable, and receiving said examination data utilizing radio.

21. A method of providing medical diagnostic services by an examination provider, the method comprising:
a. Subscribing by the examination provider to a subscriber network upon satisfaction by the examination provider of a condition;
b. Receiving by the examination provider of an examination equipment from a system operator as a benefit of subscribing to said subscriber network;
c. Retaining by the examination provider of said examination equipment for a duration of said subscription of the examination provider to said subscriber network;
d. Conducting by the examination provider of a physical examination of a patient using said examination equipment;
e. Collecting of examination data generated by the examination equipment as a result of said physical examination;
f. Transmitting by the examination provider of said examination data to a system operator using a means for transmitting said examination data, said system operator evaluating said examination data utilizing an evaluation technology, said evaluation technology comprising an automated expert system;
g. Receiving by the examination provider of a testing fee for conduct of said physical examination.

22. The method of claim 21 wherein said examination equipment is selected from the list consisting of dynamic neuromyography, X-ray, MRI, CAT, EEG and EKG equipment.

23. The method of claim 22 wherein said condition for subscribing to said subscriber network comprises providing a location for said examination equipment and providing a personnel to operate said examination equipment.

24. The method of claim 23, further comprising:
a. receiving by said examination provider of training in use of said examination equipment;
b. receiving by said examination provider of protocols for use of said examination equipment;
c. receiving by said examination provider of maintenance of said equipment, said training, said protocols and said maintenance being received from said system operator as a benefit for subscribing to said subscriber network during a duration of said subscription to said subscriber network by said examination provider.

25. The method of claim 24, further comprising: surrendering by said examination provider of said examination equipment upon a termination of said subscription of the examination provider to said subscriber network.

26. The method of claim 25 wherein said means for transmitting said examination data is selected from the list consisting of: transmitting said examination data over a computer network, delivering said examination data appearing on a paper, delivering of electronic media containing said examination data, transmitting said examination data by an auditory information, transmitting said examination data over a cable, and transmitting said examination data utilizing radio.

27. The method of claim 26 wherein said step of receiving said testing fee comprises receiving said testing fee from said system operator or a broker.

28. The method of claim 27, further comprising: receiving a schedule of said physical examination of said patient from said system operator or said broker.

29. The method of claim 28, further comprising:
a. submitting by the examination provider of a claim for payment to a payor, said payment comprising a testing fee for said examination of said patient and a reading fee for said evaluating of said examination data by said system operator, said payment further comprising an administrative fee for operation of said subscriber network by said system operator;
b. receiving by the examination provider of said payment from said payor;
c. paying by said examination provider of said reading fee and said administrative to said system operator.

30. The method of claim 26 wherein said system operator comprises an evaluating entity, said step of transmitting by the examination provider of said examination data comprising: receiving by said evaluating entity of said examination data, said evaluating entity performing said evaluation of said examination data using said automated expert system.

31. The method of claim 30 wherein said system operator comprises a network administrator, said network administrator allowing said examination provider to perform said step of subscribing to said subscriber network upon satisfaction of said condition, said network administrator providing said examination provider with said equipment, said network administrator providing said examination provider with said training, said protocols and said maintenance.

32. The method of claim 26 wherein said step of conducting said physical examination of said patient by said examination provider using said examination equipment occurs at a home or a business of said patient.

33. A method of providing medical diagnostic services by an evaluating entity, the method comprising:
a. Receiving by the evaluating entity of examination data, said examination data being collected during a physical examination of a patient by an examination provider, said examination provider subscribing to a subscriber network upon satisfaction by said examination provider of a condition; said examination provider receiving examination equipment as a benefit of subscribing to said subscriber network, said examination data being collected utilizing said examination equipment;
b. Evaluating by the evaluating entity of said examination data by application of an evaluation technology;
c. Producing a report by the evaluating entity of said evaluation of said examination data;
d. Transmitting by the evaluating entity of said report to a prescribing physician;
e. Receiving by the evaluating entity of a reading fee for said evaluating of said examination data and producing said report of said evaluation.

34. The method of claim 33 wherein said examination equipment is selected from the list consisting of a dynamic neuromyography, an X-ray imaging device, an MRI imaging device, a CAT imaging device, an EEG and an EKG.

35. The method of claim 34 wherein said evaluation technology comprises an automated expert system.

36. The method of claim 35 wherein said step of receiving by the evaluating entity of said reading fee comprises receiving said reading fee from a broker, a network administrator, said examination provider, or a system operator.

37. The method of claim 36 wherein said examination provider retains said examination equipment during a duration of said subscription by said examination provider to said subscriber network and said examination provider relinquishes said examination equipment upon termination of said examination provider's subscription to said subscriber network.
